(19) United States
(12) Patent Application Publication
(10) Pub. No.: US 2004/0089387 A1
(43) Pub. Date: May 13, 2004

(54) Prevention of gas leakage in the vehicle wheels

(76) Inventor: Hua Fu Yu, Flushing, NY (US)

Correspondence Address: YU HUA FU, #138/33, 60 Avenue, Flushing, NY, 11355, US

(21) Appl. No.: 10/291,505

(22) Filed: Nov. 12, 2002

(51) Int. Cl. B29D 30/06; B60C 19/00; B60C 19/12

(52) U.S. Cl. 152/504; 156/115

(57) ABSTRACT

It is a method of prevention of gas leakage in the vehicle wheels, if the tires was broken a by the glass, pin, etc . . . , the method could replace and recover the broken tires and reduce the gas leakage automatically The method is that the surface of tire could be designed extensionly outside to form a curved surface of wheel, and tire inside and outside could be fixed an adhensive and sticker plastic. The prevention of gas leakage is very obvious. If the tire is pined into by the iron pin of diameter of 1 mm-6 mm and the length 1 cm-10 cm, no matter whether the pin is pull out or not, the broken tire could be used as the normal continuously more than 2000 KM by the speed 120 Km/Hour without the gas leakage. This method could solve the gas leakage when then tire is pinned or broken without needing to repair immediately, it reduce a lot of repair cost and the economic benefit to the public.

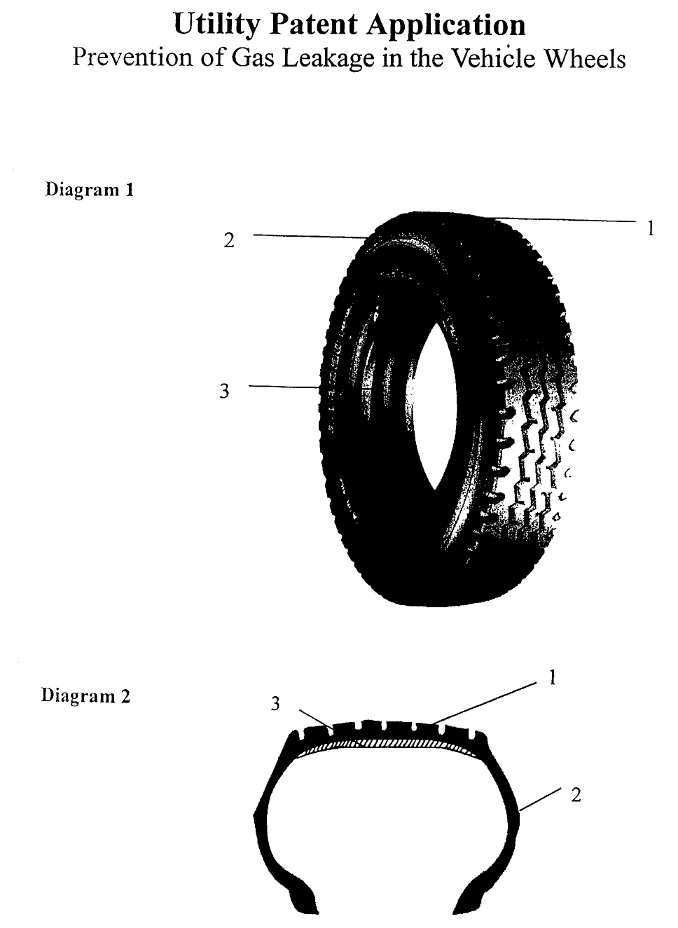

This utility invention is one type of prevention of gas leakage method in the vehicle wheel. Now, there is a technology named as “Keeping gas in the running”, it could be described as “no pressure wheel tire”, it improve the fiction of wheel tire in the situation of “no pressure or lesser pressure in the running”, the wheel could run as normal in the speed of 80 Km/Hour in a distance until the repairing. If the spare tire could be removed in the car, it could increase the space for taking the goods and reduce the weight of the car. This tire is made by the double super strong metal material and side of the wheel tire is made by the artificial super strong metal, in additional to the special wheel structure, the broken tire could run normally, and it prevent the leakage of gas. However, this technology has three immerits.

1) It could not solve the problem of gas leakage gradually.

2) The broken tire must be arranged to repair in the near repairing center.

3) The cost of production is too great, it is difficult to promote to the public.

Our new technology could be used to solve the above three immerits.

It is a method of prevention of gas leakage in the vehicle wheels, if the tires was broken a by the glass, pin, etc . . . , the method could replace and recover the broken tires and reduce the gas leakage automatically. The method is that the surface of tire could be designed extensionly outside to form a curved surface of wheel, and tire inside and outside could be fixed an adhensive and sticker plastic. The prevention of gas leakage is very obvious. If the tire is pined into by the iron pin of diameter of 1 mm-6 mm and the length 1 cm-10 cm, no matter whether the pin is pull out or not, the broken tire could be used as the normal continuously more than 2000 KM by the speed 120 Km/Hour without the gas leakage. This method could solve the gas leakage when then tire is pinned or broken without needing to repair immediately, it reduce a lot of repair cost and the economic benefit to the public. The last result is that the broken tire could be recovered automatically, no need to repair.

Referring to the diagram 1, it shows the new utility structure.

Referring to the diagram 2, it shows the new utility surface structure.

According to the diagram, this utility patent include the 1 in the diagram and the surface of tire could be designed extensionly outside to form a curved surface of wheel 2 in the diagram, 1 and 2 are fixed the adhensive plastic fixing in the 3 in the diagram. All could be described to be the rubber, to conclude, it is the combination rubber—which was combined many material and then heating, freezing until to form the combination rubber, the length is 176 cm and width is 18 cm and the thick is 3 mm.

1. The method is that the surface of tire could be designed extensionly outside to form a curved surface of wheel, and tire inside and outside could be fixed an adhensive and sticker plastic.

2. The method of claim 1, the feature of the method is the descriptive of the adhensive plastic fixing rubber

3. The method of claim 2, the feature of the method is the combination of the adhensive plastic fixing rubber.
